(19) United States
(12) Patent Application Publication
(10) Pub. No.: US 2025/0125961 A1
(43) Pub. Date: Apr. 17, 2025

(54) SYSTEMS AND METHODS GENERATING AND MANAGING NON-FUNGIBLE TOKENS

(71) Applicant: Aristocrat Technologies, Inc., Las Vegas, NV (US)

(72) Inventors: Sean Chapel, Kiowa, CO (US); Timothy Williams, Frederick, MD (US)

(21) Appl. No.: 18/590,898

(22) Filed: Feb. 28, 2024

Related U.S. Application Data
(60) Provisional application No. 63/589,599, filed on Oct. 11, 2023.

(51) Int. Cl. H04L 9/32; A63F 13/70; G06Q 20/36; H04L 9/00

(52) U.S. Cl. CPC H04L 9/3213; A63F 13/70; G06Q 20/3672; H04L 9/50; A63F 2300/575

(57) ABSTRACT

The disclosed computer-implemented method may include pre-minting at least one NFT on a blockchain by a token management service in advance of the token management service receiving a request for the at least one NFT; receiving, by the token management service, the request for the at least one NFT; and providing, by the token management service, the at least one pre-minted NFT in response to the request. Various other methods, systems, and computer-readable media are also disclosed.

### RELATED APPLICATION DATA

This application claims the benefit of U.S. Application No. 63/589,599, filed 11 Oct. 2023, the disclosure of which is incorporated, in its entirety, by this reference. In addition, this application is filed concurrently on 28 Feb. 2024 with U.S. Application No. TBD titled “SYSTEMS AND METHODS FOR DISPLAYING PLAYER MATCHUPS WITH DYNAMICALLY SELECTED DIFFICULTY LEVELS” and U.S. Application No. TBD titled “SYSTEMS AND METHODS FOR DISPLAYING PLAYER MATCHUPS WITH DYNAMICALLY SELECTED BOTS OF VARYING STRENGTH LEVELS”, the disclosures of which are incorporated, in their entirety, by this reference.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

In some cases, electronic gaming machines may provide access to other types of games including various types of video games. These video games may also be provided on mobile phones, tablets, personal computers or other computing systems. These electronic gaming machines, mobile phones, and other computing systems each have their own graphics processing systems, which may include a dedicated or shared graphics processing unit (GPU), central processing unit (CPU), dedicated or shared memory, hardware memory controllers and input/output (I/O) controllers (e.g., northbridges and southbridges), and other hardware components. Some or all of these components may be implemented when generating and presenting a video game on a display. In many cases, these components can become overwhelmed during the graphics generation process, which may, in turn, slow down the video game and lead to noticeable degradation in gameplay.

Still further, some video games may incorporate the use of special items. These special items may be digital characters or digital equipment or other digital items that are unique in the game. To ensure that these special items are not copied within the game, they may be tied to a blockchain. The blockchain may keep an immutable record of the special item's creation and may also indicate ownership of the item. Blockchain services that generate these special items, however, are often slow and unreliable and, thus, may not be available when needed during the course of a video game session.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 illustrates several different models of EGMs which may be networked to various gaming related server.

FIG. 2A is a block diagram depicting exemplary internal electronic components of a gaming device 200 connected to various external systems.

FIG. 2B depicts an example casino gaming environment.

FIG. 2C is a diagram that shows examples of components of a system for providing online gaming.

FIG. 3 illustrates, in block diagram form, an implementation of a game processing architecture 300 that implements a game processing pipeline for the play of a game.

FIG. 4 illustrates an example system for generating and managing non-fungible tokens.

FIG. 5 illustrates an example computing environment for generating and managing non-fungible tokens.

FIG. 6 illustrates an example inter-system method for generating and managing non-fungible tokens.

FIG. 7 illustrates an example computer-implemented method for generating and managing non-fungible tokens.

Throughout the drawings, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The present disclosure is generally directed to methods and systems for generating and managing non-fungible tokens (NFTs) within a video game environment. Some video games may allow players to win, purchase, trade, and/or use NFTs within and/or in conjunction with the game. NFTs may provide true digital ownership for game elements (e.g., in-game items, characters, and/or other features). NFTs may provide players with a sense of engagement and may enrich gameplay. However, where the creation of NFTs rely on external blockchain systems not fully in the control of video game developers, players may experience latencies associated with creating and deploying NFTs, potentially disrupting the user experience.

The systems described herein may reduce and/or eliminate latency in digital gaming systems and/or NFT provisioning systems by pre-minting NFTs before they are needed (e.g., before an in-game event, such as an achievement or a purchase, that entitles a player to the NFT) has occurred. In some examples, a digital game platform may serve instances of a video game to many users, and may estimate (e.g., based on the number of current users and/or new users) how many NFTs are expected to be needed. The digital game platform may, in communication with an NFT management system, pre-mint enough NFTs to maintain a pool of pre-minted NFTs sufficient to meet anticipated demand. When a player is eligible for an NFT, these systems may provide the NFT from the pool of pre-minted NFTs instead of introducing latency (e.g., in-game latency) by minting the NFT in response to determining that the player is eligible for the NFT.

By maintaining a pool of pre-minted NFTs and providing pre-minted NFTs in response to in-game events, the systems and methods described herein may improve the functioning of a player computing device, of a digital game platform, and/or of a NFT provisioning system by reducing latency and/or balancing or offloading the use of computing resources, which may otherwise affect the performance of the player computing device and/or of the digital game platform. Thus, in some examples, these systems and methods may improve the functioning of a computer itself. In addition, these systems and methods may represent an advancement in the fields of video gaming and blockchain technology.

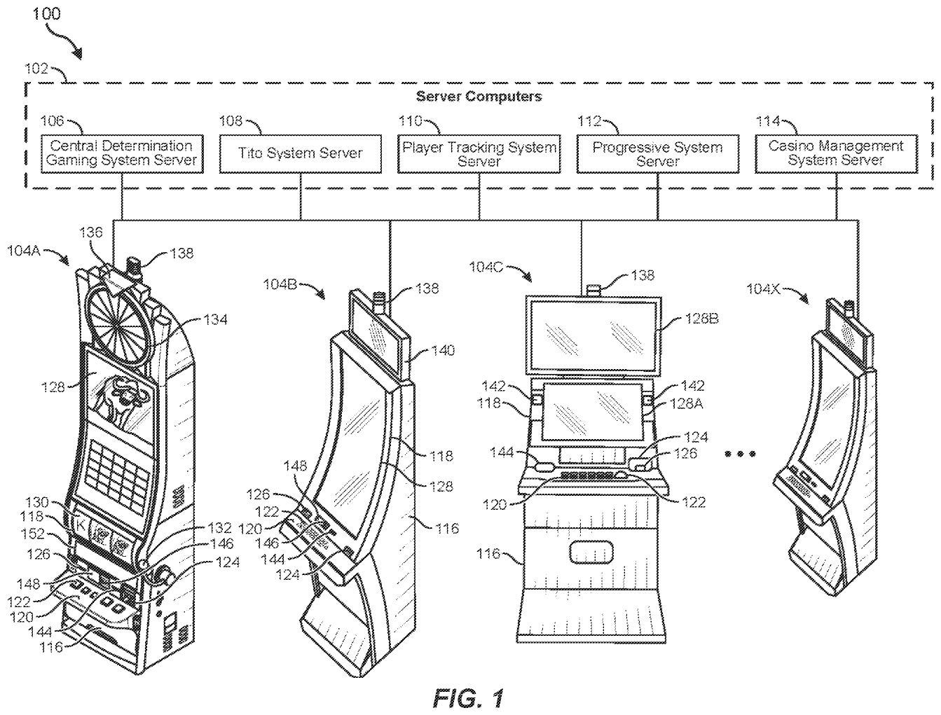

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XLTM model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

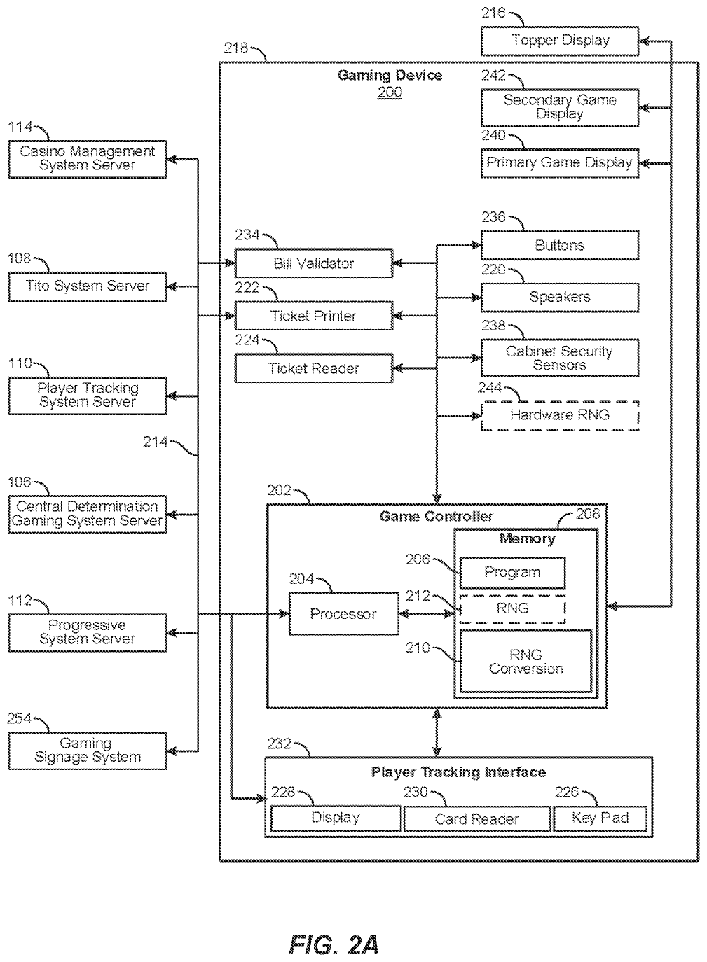

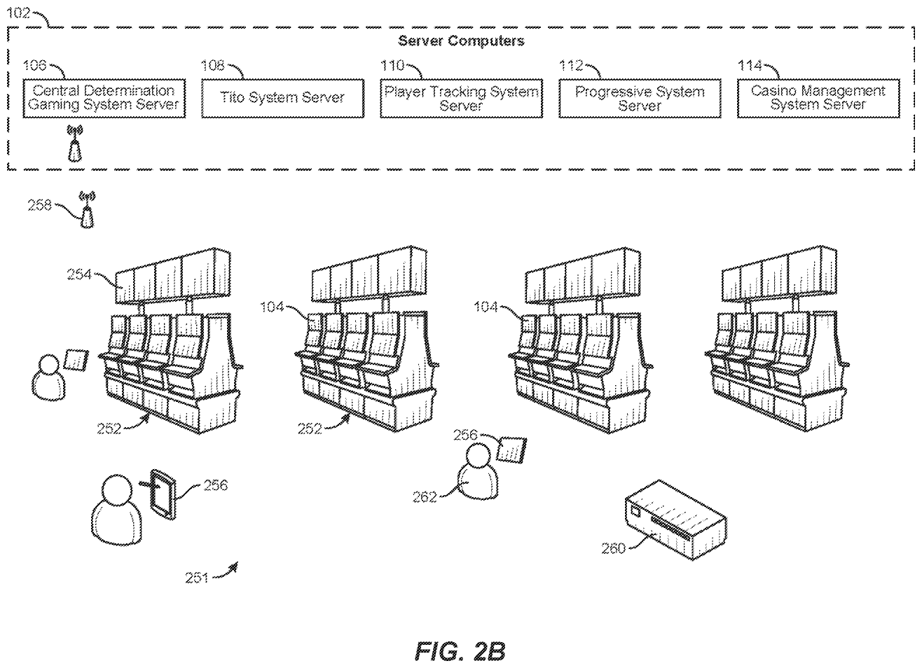

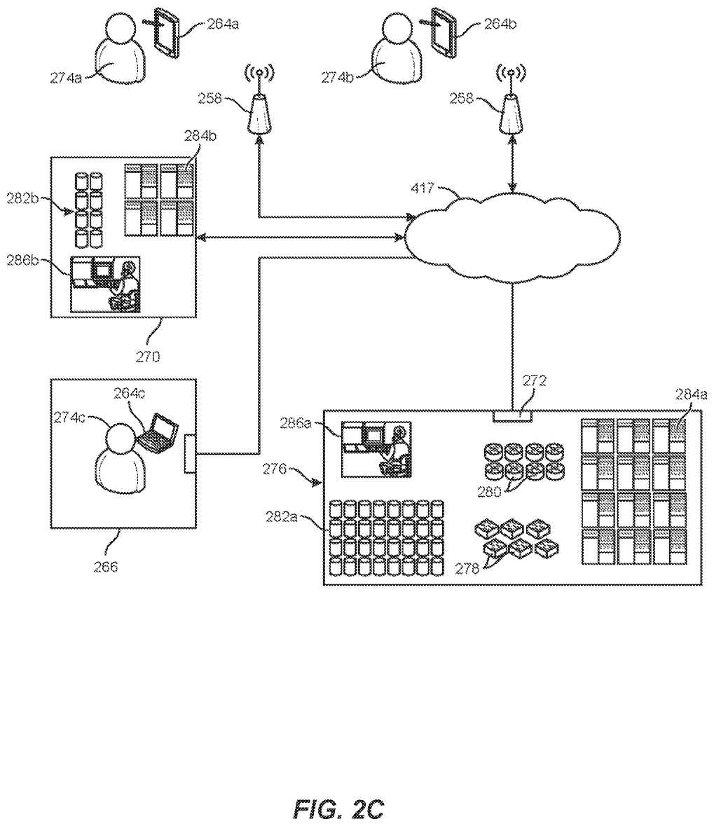

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the ArcTM model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the HelixTM model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, may be regulated to ensure fairness and, in some cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general-purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, various gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

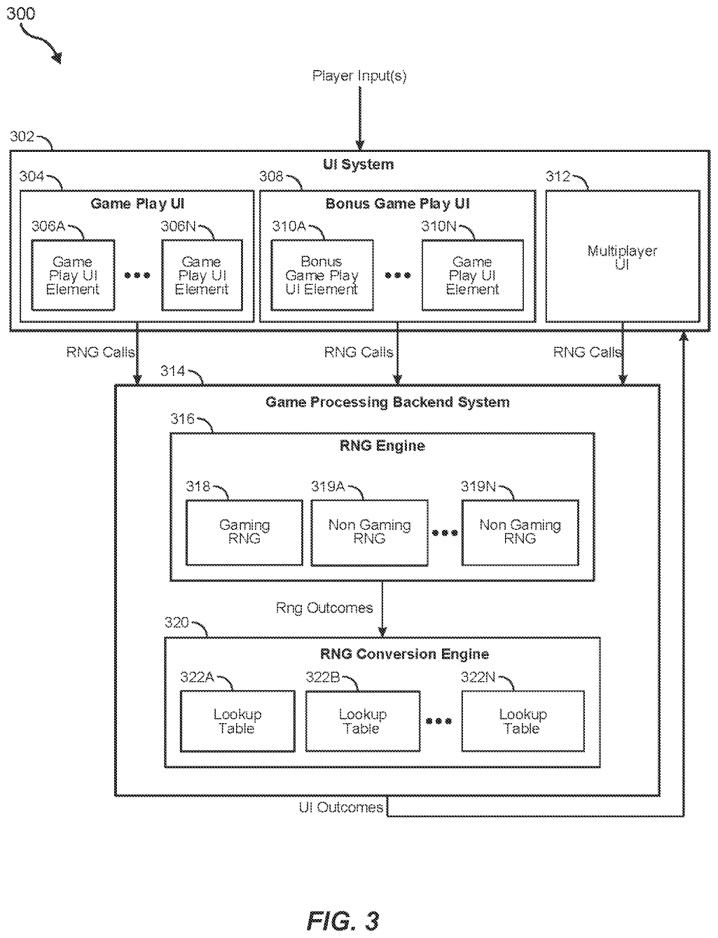

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As noted above, this disclosure is generally directed to methods and systems for creating and managing non-fungible tokens (NFTs). In one embodiment, a computer-implemented method may include establishing a token management service. The token management service may be configured to: 1) create NFT minting requests, in response to which a separate blockchain service will mint the NFT on a blockchain, 2) at least temporarily store pre-minted NFTs, and/or 3) distribute the pre-minted NFTs within a video game platform. At least in some cases, the token management service may also be configured to perform other tasks related to processing and managing NFTs.

The computer-implemented method may further include, receiving, at the token management service, an indication that an NFT is to be generated for a user. The user may be playing a video game, for example, and may wish to purchase or otherwise access a specific NFT that is to be associated with that user and used within one or more video games. The computer-implemented method may then access a stored, pre-minted NFT that was previously minted by the separate blockchain service, may provide the pre-minted NFT to the user (or to the user's electronic device), and may synchronize with the separate blockchain service to record, in the blockchain, that the pre-minted NFT was provided to the user.

In some embodiments, the separate blockchain service may be configured to mint the NFT on a distributed ledger of the blockchain. This may ensure that the NFT is immutable and cannot be copied or changed without making such changes known on the blockchain. In some cases, providing the pre-minted NFT to the user may include providing the pre-minted NFT to an account associated with the user and/or with the video game. In other cases, providing the pre-minted NFT to the user may include providing the pre-minted NFT to an electronic device associated with the user and/or with the video game.

The NFT may be stored in a custodial wallet that is managed by the token management service. This custodial wallet may be a cache or data store that holds pre-minted NFTs. The user may have a digital wallet with one or more items. These items may be recorded on the blockchain. During the time that the token management service is storing the pre-minted NFTs in the custodial wallet, one or more systems executing the video game may use the token management service as the source of truth for those pre-minted NFTs and may dictate each NFT's various properties, including when the NFT was created, who the NFT belongs to, the size and/or appearance of the underlying digital item, or other characteristics of the NFT.

In at least some embodiments, the pre-minted NFT may be provided to the user (or to the user's associated electronic device(s)) without requiring a process of minting a new NFT in response to identifying the need for the NFT. This may allow the user to immediately acquire and use the NFT within the video game, substantially without any lag or waiting time. In addition to eliminating or at least substantially reducing wait time before using the NFT, the embodiments herein may also greatly reduce reliance on third-party services for performing general blockchain operations, which may be unreliable or slow. Instead, the token management service may facilitate the pre-minting of NFTs expected to be needed in the future, allowing them to be implemented immediately within the video game without having to wait for external, potentially third-party, NFT generation services.

At least in some embodiments, the token management service may be configured to ensure that a minimum threshold number of pre-minted NFTs are maintained in storage. The token management service may initiate the generation of multiple pre-minted NFTs and may store such in a custodial wallet. As soon as the number of pre-minted NFTs in the custodial wallet dips below a minimum threshold amount, the token management service may request that more NFTs be pre-minted. This may ensure that the various players of the video game will have a steady supply of readily available NFTs whenever they are won, purchased, or otherwise accessed. In this manner, the token management service can provide unique, pre-minted NFTs to users substantially immediately upon request, without having to rely on a third-party NFT generation service. This may add reliability and stability to an otherwise unpredictable process and may ensure that NFTs are securely provided to users in an efficient, yet verifiable and trustable manner.

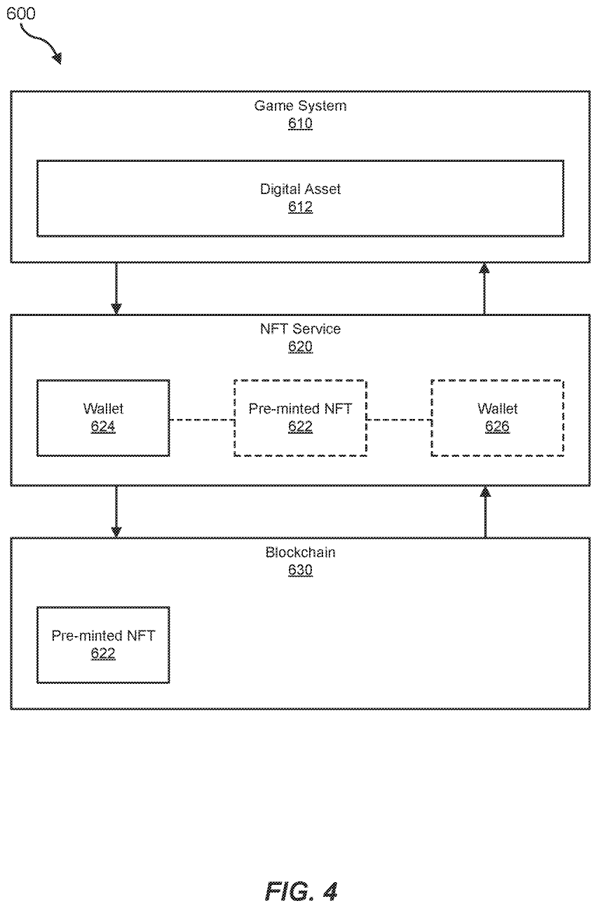

FIG. 4 illustrates an example system 600 for generating and managing non-fungible tokens. As shown in FIG. 4, system 600 may include an NFT service 620 in communication with a game system 610 and a blockchain 630.

Game system 610 may represent any digital system configured to provide a digital game to play to a user. In various examples, game system 610 may include a client-side device, a server-side device, and/or both. In some examples, game system 610 may include a device on which a user plays a digital game. For example, game system 610 may include a mobile device (e.g., a smartphone or tablet), a laptop, a desktop, a virtual reality or augmented reality device, a gaming console, and/or an electronic gaming machine (including, but not limited to, slot games, video poker games, video blackjack games, roulette games, video bingo games, and keno games). In some examples, game system 610 may include one or more servers in communication with a player client device that provide backend functionality for the digital game and/or that stream the game. In some examples, game system 610 may be a part of an online gaming platform that provides a digital game to multiple users (e.g., in a shared gaming environment, such as a massive multiplayer online game, or in separate gaming environments) at the same time.

In some examples, the digital game of game system 610 may include a digital asset 612. Digital asset 612 may include any of a variety of digital assets relating to a digital game. In some examples, digital asset 612 may correspond to an element of the digital game. For example, digital asset 612 may correspond to an item within the digital game, a character within the game, a player ability within the game, a resource within the game, a feature and/or mode of the game, and/or a player attribute within the game. Generally, digital asset 612 may correspond to any aspect of the digital game.

As will be explained in greater detail below, in some examples game system 610 may provide a player with an NFT representing digital asset 612. Game system 610 may provide the player with the NFT in any suitable context. For example, game system 610 may provide the player with the NFT when the player purchases the NFT (e.g., using traditional currency or in-game currency), when the player unlocks the NFT through gameplay (e.g., by progressing to a specific level, area, and/or plot point, or by discovering or acquiring digital asset 612 within the digital game, or by interacting with digital asset 612 in a predetermined way within the digital game), and/or when the player trades for the NFT (e.g., with another player). While examples described herein may focus on the player acquiring the NFT in real-time within the digital game, in some examples the NFT may be tradeable, saleable, and/or otherwise transferrable outside the digital game (e.g., via transactions on the blockchain that stores records relating to the NFT). In addition, in some examples the NFT may be useable in contexts outside of the digital game. For example, the NFT may be useable in other digital games (e.g., where digital asset 612 represents an item, the player may use the NFT to use the item in another digital game; where digital asset 612 represents a character, the player may use the NFT to play as and/or summon the character in another digital game; etc.).

In some examples, game system 610 may rely in part on a blockchain 630 to determine whether and/or how digital asset 612 applies to the gameplay of a player in the digital game. For example, if blockchain 630 represents an NFT corresponding to digital asset 612 as owned by and/or assigned to the player, then game system 610 may provide access to digital asset 612 to the player within the digital game. In some examples, the digital game may involve the acquisition and the use of digital asset 612 in the same play session. In some examples, the digital game may involve real-time acquisition and use of digital asset 612. For example, a player may acquire digital asset 612 through gameplay and immediately use digital asset 612, trade digital asset 612 with another player, and/or view ownership of digital asset 612. Thus, any latency between the player's acquisition of digital asset 612 and the player's ability to use, trade, and/or view ownership of digital asset 612 may be disruptive to the player's experience of the digital game. For example, if the player were required to wait after a game event which awards digital asset 612 to the player for the corresponding NFT to be minted, the player could become impatient, bored, concerned, or confused. In addition, the immersion provided by the gameplay could be broken. Furthermore, the player could be temporarily prevented from taking certain actions with the digital game. In some examples, any latency could cause an error condition as the logic of the game might both assume that the player has received digital asset 612 (due to the game event) and determine that the player does not have digital asset 612 (due to the state of blockchain 630).

To prevent latency between a game event awarding digital asset 612 to the player, an NFT service 620 may generate a pre-minted NFT 622. For example, NFT service 620 may mint pre-minted NFT 622 on blockchain 630 before game system 610 requests an NFT for the player for digital asset 612. Thus, for example, NFT service 620 may mint pre-minted NFT 622 before the player purchases, earns, or otherwise acquires digital asset 612. In some examples, NFT service 620 may mint pre-minted NFT 622 before the player initiates the gaming session in which the player is awarded digital asset 612. Thus, pre-minted NFT 622 may be immediately available for use by the player and/or game system 610 to represent the player's ownership of digital asset 612. Accordingly, gameplay, the ability of the player to use digital asset 612 within the game, and/or the ability of the player to trade digital asset 612 may not be delayed, interrupted, and/or interfered with.

In one example, NFT service 620 may assign pre-minted NFT 622 to a wallet 624. As used herein, the term “wallet” may refer to any cryptocurrency wallet (or information uniquely relating to a specific cryptocurrency wallet, such as a cryptocurrency address and/or a public key) that stores credentials that provide ownership and/or control of assets recorded in a blockchain. As used herein, the wallet may be said to “store” the assets. In some examples, wallet 624 may be a custodial wallet. As used herein, the term “custodial wallet’ may refer to any wallet owned and/or administered by a third party on behalf of another. For example, a gaming company (and/or an administrator acting on behalf of the gaming company) may control a custodial wallet that stores one or more NFTs (such as NFT 622) on behalf of a player. In some examples, wallet 624 may be a wallet owned and/or controlled by the player. For example, the player may have provided a public cryptocurrency key and/or address to game system 610 and/or NFT service 620. NFT service 620 may pre-mint NFT 622 in association with a custodial wallet and later transfer NFT 622 to the player's wallet. In one example, NFT service 620 may pre-mint NFT 622 in association with wallet 624 (e.g., a custodial wallet and/or a wallet pertaining to game system 610 in general) and later transfer NFT 622 to a wallet 626 (e.g., the player's wallet and/or a custodial wallet specific to the player).

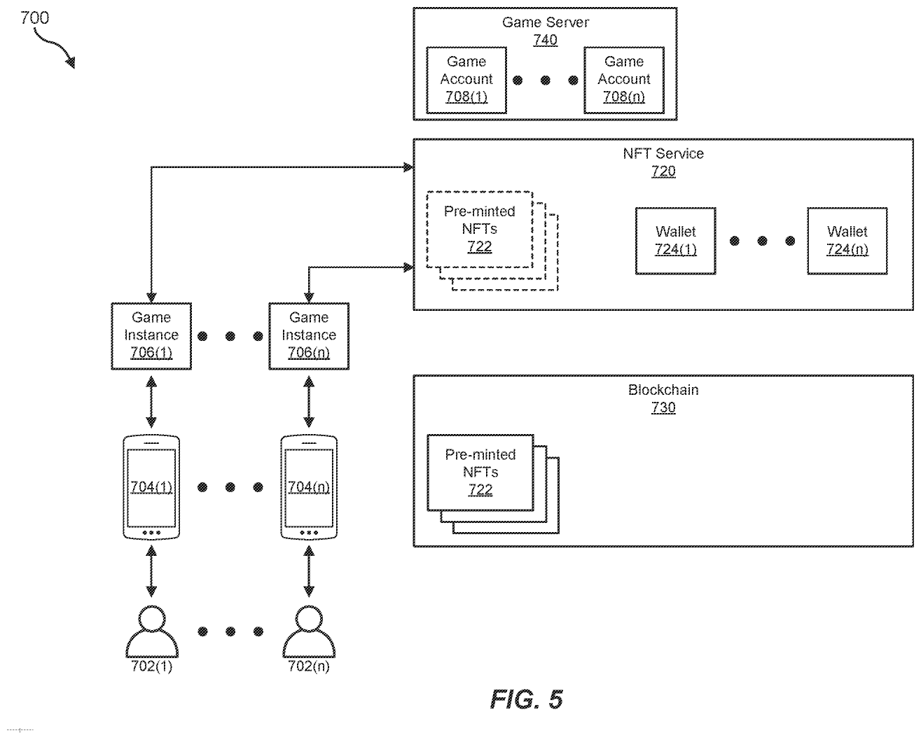

FIG. 5 illustrates an example computing environment 700 for generating and managing non-fungible tokens. As shown in FIG. 5, computing environment 700 may include client devices 704(1)-(n) used to play game instances 706(1)-(n) by players 702(1)-(n), respectively. In some examples, game instances 706(1)-(n) may execute entirely on client devices 704(1)-(n). In some examples, game instances 706(1)-(n) may execute largely on one or more servers, such as a game server 740. Regardless of where game instances 706(1)-(n) execute, in some examples game instances 706(1)-(n) may provide information to NFT service 720 relating to an anticipated number of NFTs needed in the future across game instances 706(1)-(n). For example, game instances 706(1)-(n) may provide information regarding the number of game instances (e.g., simply by communicating with game server 740 and/or NFT service 720). In some examples, game instances 706(1)-(n) may use gameplay information to anticipate potential needs for particular types of NFTs (i.e., NFTs relating to particular digital assets). In one example, NFT service 720 may maintain a pool of pre-minted NFTs sufficient to meet expected demand (e.g., without running out before they can be replenished). For example, NFT service 720 may pre-mint NFTs until the number of pre-minted NFTs in the pool matches a threshold (e.g., set by the expected demand).

Accordingly, NFT service 720 may pre-mint NFTs 722 on a blockchain 730. When a new player joins the digital game (e.g., opening a new game instance within game instances 706(1)-(n)), NFT service 720 may pre-mint another NFT to add to NFTs 722. Additionally or alternatively, when one of pre-minted NFTs 722 is consumed (i.e., assigned to a specific player), NFT service 720 may pre-mint another NFT to add to NFTs 722.

In some examples, NFT service 720 may place pre-minted NFTs 722 in separate wallets 724(1)-(n). For example, wallets 724(1)-(n) may be custodial wallets created on behalf of prospective players. Additionally or alternatively, NFT service 720 may use a single custodial wallet to store pre-minted NFTs, and NFT service 720 and/or game server 740 may separately track which NFTs pertain to which player.

In one example, an NFT may be temporarily allocated to a game instance and later allocated to the corresponding player when the player creates an account. For example, player 702(1) may start playing game instance 706(1) without first creating a player account. Player 702(1) may then earn an NFT through gameplay, and game instance 706(1) may request the NFT from NFT service 720. NFT service 720 may provide one of pre-minted NFTs 722 in response, avoiding any delay. Later, player 702(1) may decide to continue playing the digital game in the long term and to preserve progress in the game (including the earned NFT) by creating a game account 708(1). Game server 740 may then associate the earned NFT with game account 708(1). In some examples, a player may abandon a temporarily assigned NFT (e.g., that is maintained in a custodial wallet by game server 740 and/or NFT service 720) by deleting and/or failing to maintain their game account. In this example, game server 740 and/or NFT service 720 may return the abandoned NFT to the pool of pre-minted NFTs 722 such that it is available for later reassignment to another game instance requesting an NFT. In some examples, one or more of the systems described herein may transfer an NFT to a player's personal wallet, in which case the player may have the sole ability to keep or transfer the NFT.

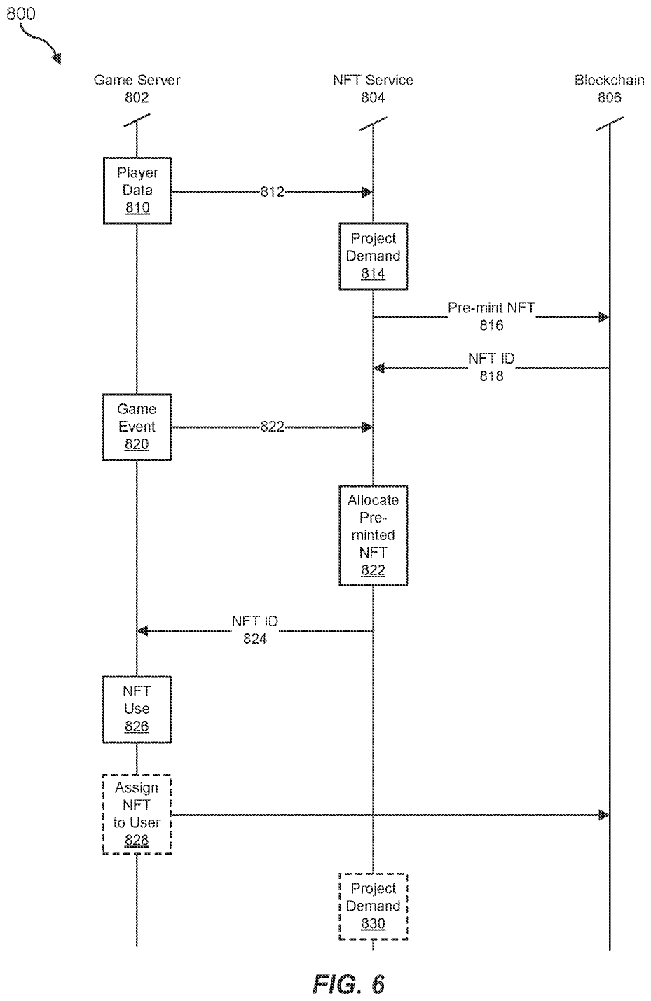

FIG. 6 illustrates an example inter-system method 800 for generating and managing non-fungible tokens. As shown in FIG. 6, method 800 may involve a game server 802, an NFT service 804, and a blockchain 806. In one example, game server 802 may provide, based on player data 810, data 812 to NFT service 804 useful to determining a demand for NFTs by game server 802. For example, game server 802 may provide information regarding a number of current players eligible to receive an NFT corresponding to a digital asset in the future. In response, NFT service 804 may, at a step 814, project future demand for NFTs for the digital asset. Based on the projected demand, at a step 816 NFT service 804 may pre-mint sufficient NFTs on blockchain 806 to meet the projected demand (e.g., immediately as demand arises). NFT service 804 may receive NFT ID information 818 from blockchain 806 that identifies the pre-minted NFTs.

Later, game server 802 may identify a game event 820 that entitles a player to an NFT. Game server 802 may therefore, at a step 822, request an NFT from NFT service 804. Because NFT service 804 has pre-minted the NFT, NFT service 804 may, at a step 822, allocate the pre-minted NFT in response to the request. NFT service 804 may then, at a step 824, provide NFT ID information in response to the request. Game server 802 may then, at a step 826, use the NFT in a player's game session (e.g., allowing the player to use a digital asset in the game represented by the NFT).

In some examples, up to step 826 game server and/or NFT service 804 may have managed the NFT in a custodial wallet. However, at a step 828, game server 802 and/or NFT service 804 assign give the NFT to the player (e.g., transfer the NFT to a wallet specific to the player). For example, the NFT may vest to the player following a vesting event (e.g., where the player makes a purchase within the digital game, the player registers an account for the digital game, and/or another event within the digital game occurs). To provide ongoing access to the NFT following the vesting event, game server 802 may request that NFT service 804 transfer the NFT to the player's wallet. NFT service 804 may then record the transfer on blockchain 806. The player may then be able to own and/or transfer the NFT outside game server 802 at the player's discretion.

In some examples, at a step 830 NFT service 804 may again project the demand for NFTs (e.g., potentially needing to replenish the pool of pre-minted NFTs after one was allocated in step 822).

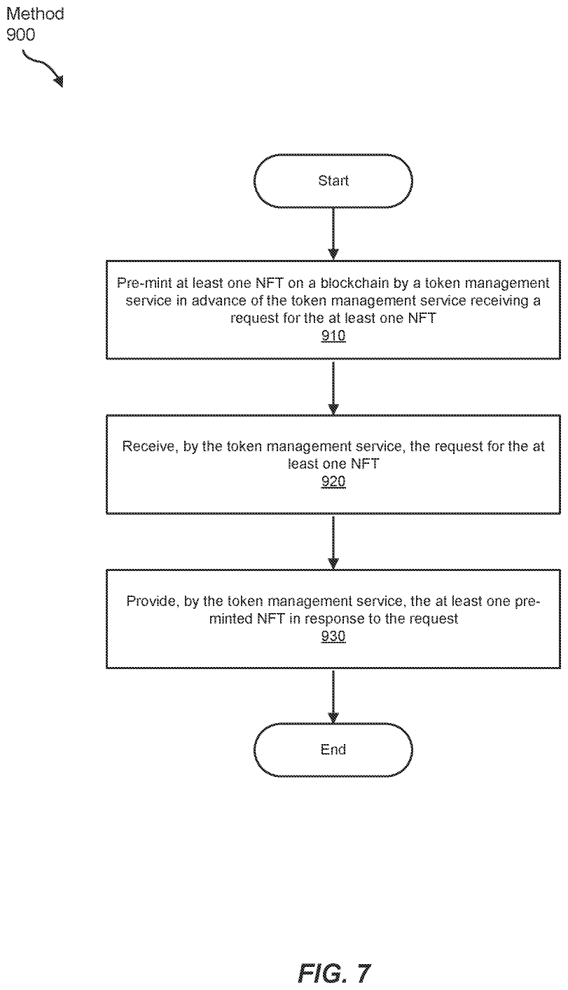

FIG. 7 illustrates an example computer-implemented method 900 for generating and managing non-fungible tokens. As shown in FIG. 7, at a step 910 method 900 may include pre-minting at least one NFT on a blockchain by a token management service in advance of the token management service receiving a request for the at least one NFT. For example, NFT service 620 of FIG. 4 may pre-mint NFT 622 in advance of receiving a request for the NFT from game system 610.

Returning to FIG. 7, at a step 920, method 900 may include receiving, by the token management service, the request for the at least one NFT. For example, NFT service 620 of FIG. 4 may receive a request for an NFT (e.g., of a type corresponding to pre-minted NFT 622) from game system 610 after NFT service 620 has already minted NFT 622.

Returning to FIG. 7, at a step 930, method 900 may include providing, by the token management service, the at least one pre-minted NFT in response to the request. For example, NFT service 620 of FIG. 4 may provide pre-minted NFT 622 to game system 610 in response to the request by game system 610 for an NFT.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable and/or computer-executable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPfGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an audio/video file to be transformed, transform the audio/video file, output a result of the transformation to detect an active speaker within the audio/video file, use the result of the transformation to evaluate dubbing for the audio/video file, and store the result of the transformation to create a task for a future workflow based on the detection of the active speaker and/or the evaluation of the dubbing. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A computer-implemented method comprising:
pre-minting at least one NFT on a blockchain by a token management service in advance of the token management service receiving a request for the at least one NFT;
receiving, by the token management service, the request for the at least one NFT; and
providing, by the token management service, the at least one pre-minted NFT in response to the request.

2. The computer-implemented method of claim 1, further comprising:
determining a number of NFTs to provision in advance of receiving the request,
wherein pre-minting the at least one NFT comprises pre-minting NFTs until a pool of available pre-minted NFTs matches the number of NFTs to provision in advance.

3. The computer-implemented method of claim 1, wherein the token management service receives the request from a digital game system.

4. The computer-implemented method of claim 3, wherein the at least one pre-minted NFT corresponds to a digital asset provided to a player of a digital game of the digital game system.

5. The computer-implemented method of claim 4, wherein the digital asset comprises a game element within the digital game of the digital game system.

6. The computer-implemented method of claim 4, wherein the digital game system bases use of the digital asset by the player at least in part on a record of the at least one pre-minted NFT on the blockchain.

7. The computer-implemented method of claim 4, wherein providing, by the token management service, the at least one pre-minted NFT in response to the request comprises providing real-time access by the player to the digital asset within the digital game.

8. The computer-implemented method of claim 4, wherein providing, by the token management service, the at least one pre-minted NFT in response to the request comprises providing a real-time ability to trade, via the blockchain and by the player, the digital asset with at least one other player of the digital game.

9. The computer-implemented method of claim 4, further comprising storing the pre-minted NFT in a wallet corresponding to the player of the digital game.

10. The computer-implemented method of claim 9, wherein the wallet comprises a custodial wallet managed by an administrator of the digital game system on behalf of the player.

11. The computer-implemented method of claim 10, further comprising:
identifying a vesting event that awards the player ongoing access to the at least one pre-minted NFT; and
in response to identifying the vesting event, assigning the custodial wallet to the player.

12. The computer-implemented method of claim 11, wherein the vesting event comprises at least one of:
the player registering an account within the digital game system;
the player making a purchase within the digital game system; or
a game event within the digital game.

13. A system comprising:
at least one physical processor; and
physical memory comprising computer-executable instructions that, when executed by the physical processor, cause the physical processor to:
pre-mint at least one NFT on a blockchain by a token management service in advance of the token management service receiving a request for the at least one NFT;
receive, by the token management service, the request for the at least one NFT; and
provide, by the token management service, the at least one pre-minted NFT in response to the request.

14. The system of claim 13, wherein the computer-executable instructions further cause the physical processor to determine a number of NFTs to provision in advance of receiving the request,
wherein pre-minting the at least one NFT comprises pre-minting NFTs until a pool of available pre-minted NFTs matches the number of NFTs to provision in advance.

15. The system of claim 13, wherein the token management service receives the request from a digital game system.

16. The system of claim 15, wherein the at least one pre-minted NFT corresponds to a digital asset provided to a player of a digital game of the digital game system.

17. The system of claim 16, wherein the digital asset comprises a game element within the digital game of the digital game system.

18. The system of claim 16, wherein the digital game system bases use of the digital asset by the player at least in part on a record of the at least one pre-minted NFT on the blockchain.

19. The system of claim 16, wherein providing, by the token management service, the at least one pre-minted NFT in response to the request comprises providing real-time access by the player to the digital asset within the digital game.

20. A non-transitory computer-readable medium comprising one or more computer-executable instructions that, when executed by at least one processor of a computing device, cause the computing device to:
pre-mint at least one NFT on a blockchain by a token management service in advance of the token management service receiving a request for the at least one NFT;
receive, by the token management service, the request for the at least one NFT; and
provide, by the token management service, the at least one pre-minted NFT in response to the request.
